(19) United States
(12) Patent Application Publication
(10) Pub. No.: US 2024/0215829 A1
(43) Pub. Date: Jul. 4, 2024

(54) Diabetic Visual Assessment System

(71) Applicant: Elizabeth Bradford, Long Beach, CA (US)

(72) Inventor: Elizabeth Bradford, Long Beach, CA (US)

(21) Appl. No.: 18/607,294

(22) Filed: Mar. 15, 2024

(51) Int. Cl. A61B 5/00

(52) U.S. Cl. CPC A61B 5/0077; A61B 5/445; A61B 2560/0431; A61B 2562/164

(57) ABSTRACT

A diabetic visual assessment system is provided which utilizes an elongate reconfigurable neck having a proximal terminal end and a distal terminal end and comprising a gooseneck segment. The gooseneck segment utilizes a plurality of gooseneck sections with each gooseneck section being separated by an articulation joint. The gooseneck segment further utilizes a first inflection joint of a plurality of inflection joints disposed between the proximal terminal end and the distal terminal end. The diabetic visual assessment system further utilizes camera coupling system having a cylindrical shaft disposed within a proximal region thereof. The camera coupling system is disposed at the distal terminal end of the elongate reconfigurable neck and the cylindrical shaft is coupled to the distal terminal end of the elongate reconfigurable neck.

### BACKGROUND OF THE INVENTION

The medical industry is constantly seeking to find new ways to reach a greater number of people and provide devices that are simple to operate. This leads to continual innovation in the field of devices usable for medical purposes, whether for treatment, reporting or diagnosis. This ever-expanding field of devices usable for medical purposes often attempts to develop devices that are usable by the greatest number of people. Often, companies fall short by providing devices that are geared toward more technologically adept users, which may alienate less technologically adept users.

Further, devices that are developed for an average user may not be usable by some of the people who would benefit from the device. The limitations some people face may be due to familiarity with technology and physical limitations. People with certain physical disabilities or limitations may be unable to use some devices due to a restriction on movement. Likewise, some elderly individuals may have restrictions on their movement or may have limited physical dexterity which may cause difficulty in using some devices properly. Therefore, it would be advantageous to provide a device that is simple to use and may be adapted to be usable by a large number of people, regardless of physical limitation.

Additionally, the physical limitations experienced by some people may have potentially damaging effects to that individual. If an individual lacks the mobility or movement capability to view various parts of their body, then sores or other injuries may develop without the individual being aware of the problem. This lack of awareness of a sore or injuries can lead to greater damage and extensive medical treatments. Therefore, a system is needed to provide users with limited mobility the tools they need to assess the condition of their own body.

Diabetes is a condition that can be dangerous if a person is unaware of damage on their body. If an elderly person or a person with limited dexterity is unable to view portions of their body, such as their back, bottom of their feet, inner ear, behind the ear, etc., a sore may develop without being noticed. If a sore persists without treatment, the injury may develop a severe infection and require extensive medical treatments. This may come at a significant cost to the user and may potentially put the user's health at risk.

Therefore, it would be advantageous to provide a system and device that allows a user to regularly inspect their body, including difficulty to reach or view locations, without the need to visit a doctor or other medical professionals. Additionally, it would be advantageous for the device to be simple to operate to allow a greater number of people to use the device. Such a device may be beneficial to people with diabetes, but may also be useful to anyone having a physical limitation that restricts motion or limits dexterity.

### BRIEF DESCRIPTION OF THE DRAWINGS

FIG. 1 illustrates a standalone view of a camera of a diabetic visual assessment system in accordance with some embodiments of the present invention.

FIG. 2 illustrates a standalone view of a flexible neck for coupling to a camera in accordance with some embodiments of the present invention.

FIG. 3 illustrates a perspective view of a diabetic visual assessment system in accordance with some embodiments of the present invention.

FIG. 4 illustrates a perspective view of using a diabetic visual assessment system in accordance with some embodiments of the present invention.

FIG. 5 illustrates a cross-sectional view of a camera coupling configuration in accordance with some embodiments of the present invention.

FIG. 6A illustrates a perspective view of a camera coupling element in accordance with some embodiments of the present invention.

FIG. 6B illustrates a perspective view of a camera coupling element coupled to a display device in accordance with some embodiments of the present invention.

### DETAILED DESCRIPTION OF THE INVENTION

Before describing the present invention in detail, it is to be understood that the invention is not limited to any one of the particular embodiments, which of course may vary. It is also to be understood that the terminology used herein is for the purpose of describing particular embodiments only, and therefore is not necessarily intended to be limiting. As used in this specification and the appended claims, terms in the singular and the singular forms “a,” “an,” and “the” include plural referents unless the context clearly dictates otherwise. Thus, for example, reference to “a diabetic visual assessment system” also includes a plurality of diabetic visual assessment systems and the like.

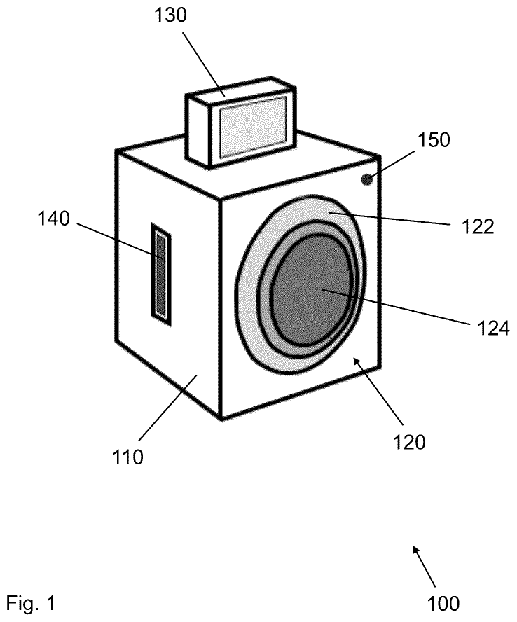

Exemplary embodiments of the present invention are illustrated in the accompanying figures. As shown in FIG. 1, a standalone view of a camera 100 is provided. The camera 100 may include circuitry for imaging, power and external communication, as is commonly known in the art. The camera 100 may comprise a body 110 and contains imaging optics 120 on a front face of the body 110. The imaging optics 120 may include a lens 124 and a focus mechanism 122. Additionally, the camera 100 may comprise a flash 130 and a power status indicator 150.

The camera 100 may additionally include a power/data port 140. The power/data port 140 may be in the form of USB-A, USB-C, micro USB, other any other suitable port connection. The power/data port 140 is capable of providing power from an external source to power the camera 100. Alternately, the power/data port 140 may provide power to an optional rechargeable battery within the camera 100. Having the optional rechargeable battery allows the camera to function with or without the use of a power cable. The power/data port 140 may be capable of providing data transfer between the camera 100 and an external device. The data transfer may be usable to transfer images or video taken by the camera 100 to be stored or viewed on an external device. Additionally, the data transfer by the power/data port 140 may deliver software updates to the camera 100 or allow external control of the camera 100.

The camera 100 may be capable of capturing images and video. The images and video may be of sufficient quality and resolution to be usable for identifying features on a user's body. The imaging optics 120 may, optionally, be customized for the desired task. The imaging optics 120 may utilize optical zoom features, image stabilization, fixed focal length optics, variable focal length optics, automatic focusing, or any combinations thereof.

Additionally, the camera 100 may have a coupling mechanism (not shown). The coupling mechanism may allow for removable attachment to various holding devices including an elongate reconfigurable neck or a modular stand. The camera 100 may be rotationally coupled to the coupling mechanism to allow for a variety of positions to be achieved with the camera 100.

Further, the camera 100 may have internal circuit components for external communication. The internal circuit components for external communication may include, but are not limited to, Bluetooth, NFC, WiFi, and the like, or any other suitable communication means. The internal circuit components for external communication may enable data transfer, including sending image and video data, to an external device. Additionally, the internal circuit components for external communication may deliver software updates to the camera 100 or allow external control of the camera 100.

Expanding on the expandable memory slot feature, the camera 100 may be designed to support a wide range of removable storage media types, including but not limited to Secure Digital (SD) cards, MicroSD cards, CompactFlash (CF) cards, and Memory Sticks. This broad compatibility ensures that users have the flexibility to choose from a variety of storage options based on their capacity needs and availability. Each type of memory card could support various storage capacities, ranging from a few gigabytes to several terabytes, catering to both casual users and professional photographers who require extensive storage for high-resolution images and videos.

The design of the memory slot in the camera 100 may be such that it allows for hot-swapping of memory cards without the need to power down the device. This feature would be particularly beneficial for users who need to quickly switch memory cards during intensive shooting sessions. Furthermore, the camera could be equipped with a dual memory card slot system, enabling simultaneous use of two memory cards. This setup could be configured for several functions, such as real-time mirroring of data for backup purposes, segregating different types of media (e.g., photos on one card and videos on another), or extending total storage capacity.

Additionally, the camera 100 may include an intelligent memory management system. This system could automatically organize and store files efficiently across the inserted memory cards, based on customizable user preferences such as file type, size, or date. The memory management system could also provide warnings when storage space is running low and suggest options to the user, like auto-archiving older files to an external storage device.

To further enhance data transfer convenience, the camera 100 might include an integrated memory card reader function. This feature would allow the camera to act as a card reader when connected to a computer or other devices, facilitating easy access to the files stored on the memory cards without the need for additional external card readers.

In terms of data security and protection, the expandable memory slot could be equipped with built-in encryption and data protection features. These features would secure the stored data against unauthorized access and ensure that sensitive information, such as personal photos or professional work, is adequately protected. Additionally, the camera 100 could offer recovery options for accidentally deleted files or corrupted data on the memory cards, adding an extra layer of data security for the user.

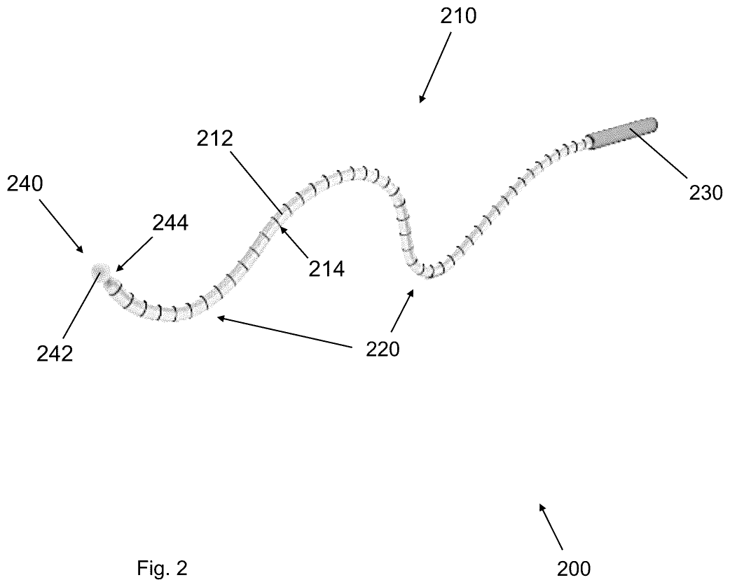

As shown in FIG. 2, a standalone view of an elongate reconfigurable neck 200 for coupling to a camera is provided. The elongate reconfigurable neck 200 may comprise a camera coupling bearing 240, a coupling handle 230, a plurality of gooseneck segments 210 and inflection joints 220. The elongate reconfigurable neck 200 is flexible and reconfigurable via the plurality of gooseneck segments 210 and inflection joints 220 which allow any number of positions to be utilized. The inflection joints 220 may include the portions of the elongate reconfigurable neck 200 which comprise an inflection point in the curvature thereof. It is to be understood that use of the term ‘gooseneck’ is not intended to limit the disclosure of the segments 210 to any specific structural design, but rather the term ‘gooseneck’ is used to convey the segments 210 as being any elongate curved object fabricated from flexible fabrication materials. Similarly, use of the term ‘gooseneck’ in any other instance in this disclosure document is intended to convey an elongate curved object fabricated from flexible fabrication materials.

A large number of gooseneck segments 210 may be included in the elongate reconfigurable neck 200. The plurality of gooseneck segments 210 may be fabricated from material comprising a soft metallic core surrounded by a hard metallic coiled spring. The soft metallic core and hard metallic coiled spring may be covered by a flexible polymer protective layer in order to protect the structural integrity of the soft metallic core and hard metallic coiled spring. Each segment of the plurality of gooseneck segments 210 may be coupled to an adjacent segment through an inflection joint 220. The inflection joint 220 provides spacing between each segment of the plurality of gooseneck segments 210 and allows relative movement between each adjacent segment.

The plurality of gooseneck segments 210 may each comprise a plurality of individual gooseneck sections 212 which are coupled together via articulation joints 214. The camera coupling bearing 240 may comprise a terminal ball bearing 242 coupled to the plurality of gooseneck segments 210 via a cylindrical distal coupling shaft 244. The coupling shaft 244 may comprise a width or diameter that is a smaller than that of the plurality of gooseneck segments 210. Similarly, the plurality of gooseneck segments 210 may comprise a width or diameter that is smaller than that of the coupling handle 230. Such a relationship is advantageous in providing better handling leverage over the

[symbol]

The elongate reconfigurable neck 200 may terminate at a second end with the camera coupling bearing 240. A terminal segment of the plurality of gooseneck segments 210 may be configured for attachment to the camera coupling bearing 240 through an inflection joint 220. This coupling allows for additional movement between the terminal segment of the plurality of gooseneck segments 210 and the camera coupling bearing 240.

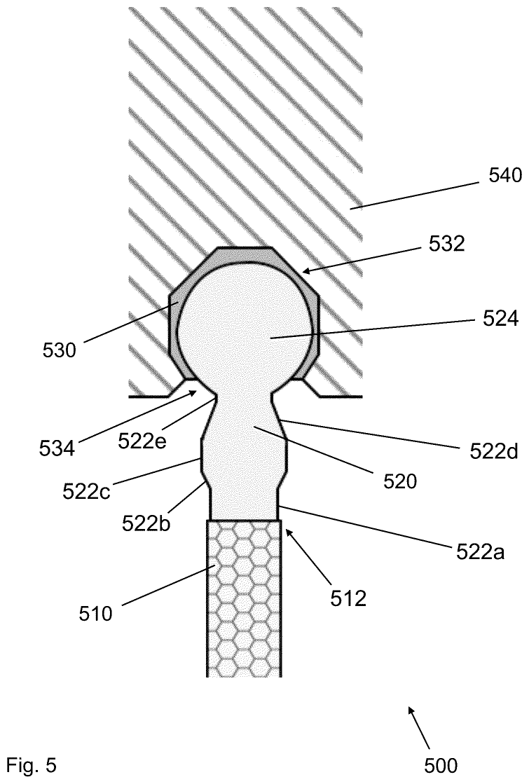

Additionally, the camera coupling bearing 240 is configured to couple with the camera 100. The camera coupling bearing 240 may have a partially spherical shape, and is configured to couple with a bottom portion of the camera 100, as illustrated in FIG. 5. The partially spherical shape allows the camera 100 to be rotatably attached to the elongate reconfigurable neck 200.

The elongate reconfigurable neck 200 may further attach to the coupling handle 230. The elongate reconfigurable neck 200 may connect to the coupling handle 230 at a proximal segment of the plurality of gooseneck segments 210 and may be configured for attachment through an inflection joint 220. The coupling handle 230 may be permanently attached to the proximal segment of the plurality of gooseneck segments 210 at a first end.

The coupling handle 230 is configured to be held with the hand of a user. The coupling handle 230 may comprise an external gripping material disposed therearound to allow the user ease of handling of the elongate reconfigurable neck 200 while the weight of the camera 100 is positioned at the distal end thereof. Additionally, the coupling handle 230 may be configured to be removably attachable to the modular stand (not shown) to provide a hands-free means of operating the camera to capture images or video of portions of the user's body that may comprise medically sensitive areas.

Enhancing the functionality of the elongate reconfigurable neck 200, it may be equipped with an internal cable routing system. This system could allow for the passage of power, data, or control cables from the camera 100 through the inside of the elongate reconfigurable neck 200 to the coupling handle 230 or further to an external device or power source. The internal cable routing system ensures a clutter-free setup and protects the cables from external damage or disconnection during movement or reconfiguration of the neck 200.

Furthermore, the elongate reconfigurable neck 200 may incorporate advanced position-locking technology. This technology could involve a locking mechanism integrated within each inflection joint 220, allowing the user to firmly secure the neck 200 in the desired position. Once locked, the neck 200 would maintain its configuration under the weight of the camera 100, even in challenging shooting environments or angles. This locking mechanism could be activated manually or electronically, with the latter allowing for remote control or programmable positioning.

In addition, the outer surface of the elongate reconfigurable neck 200 may feature a scale or markings at regular intervals. These markings can assist users in precisely repeating specific configurations or angles, valuable for tasks requiring consistent camera positioning such as time-lapse photography or scientific observations.

The camera coupling bearing 240 may also include a quick-release mechanism, facilitating rapid attachment and detachment of the camera 100. This mechanism would be particularly beneficial for photographers who need to switch quickly between handheld and mounted camera use. The quick-release mechanism could be designed to provide a secure connection while allowing for easy user operation, even with one hand.

Additionally, the coupling handle 230 might feature an integrated control panel or buttons. These controls could be connected to the camera 100 via the internal cable routing system and allow for basic camera functions such as shutter release, zoom, and focus to be controlled directly from the handle 230. This feature would be particularly useful in scenarios where the camera 100 is mounted in hard-to-reach positions or angles.

Finally, considering user comfort and ergonomics, the coupling handle 230 might be designed with an adjustable grip. This adjustable grip could conform to the user's hand size and preferred holding position, reducing fatigue during extended use. The external gripping material could be made of a non-slip, durable, and comfortable material to enhance the user's experience, especially in challenging environmental shooting conditions.

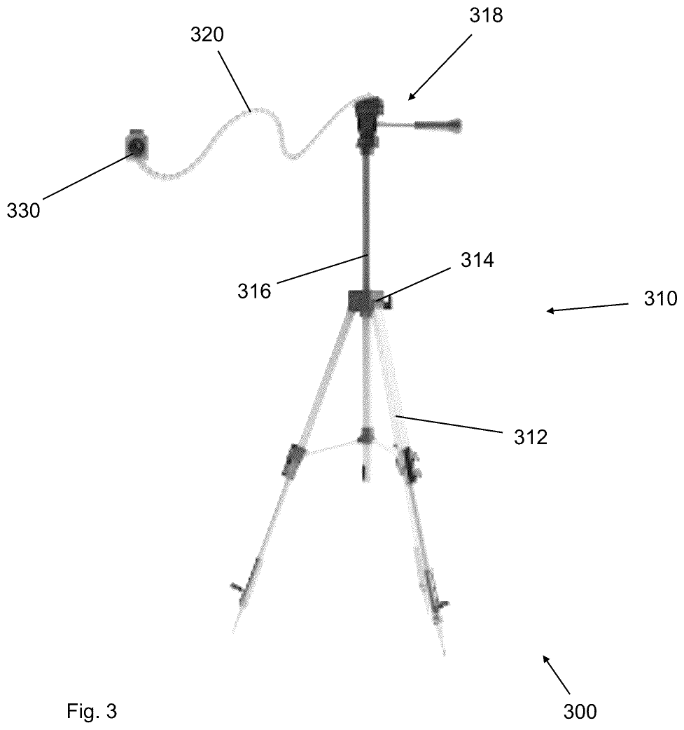

As shown in FIG. 3, a perspective view of a diabetic visual assessment system 300 including a modular stand is provided. The diabetic visual assessment system 300 comprises a camera 330, an elongate reconfigurable neck 320, a modular tripod stand 310, and a camera mount 318. The camera 330 is connected to the elongate reconfigurable neck 320 as described in reference to FIG. 2. Additionally, the elongate reconfigurable neck 320 connects to a coupling handle, which is removably attachable to the camera mount 318. The elongate reconfigurable neck 320 may be connected in a manner which allows the elongate reconfigurable neck 320 to extend out to any suitable position, including horizontally and vertically.

The modular stand may be any suitable stand including, but not limited to, a tripod stand, a flexible wrap stand, and a fixed stand. The tripod stand 310 may comprise three legs 312, a support shaft 316 and a coupling flange 314. The legs 312 may comprise extendable telescopic leg segments that allow the tripod stand 310 to be raised to a higher total height. The extendable leg segments may be locked in place at a height as desired by the user with a compression latch or with spring loaded pins and detents.

The tripod stand 310 may additionally include a support shaft 316 that is telescopic. The support shaft 316 may be extended through a gear arrangement with a crank handle or may be manually raised and locked in place with a compression latch or spring loaded pins and detents. Additionally, the tripod stand 310 may comprise a handle that allows a user to swivel the camera mount 318 about the stationary tripod stand 310 in order to rotate the camera 330 to a proper angle when it is attached thereto.

The modular stand of the diabetic visual assessment system 300 may allow a user to take images or video of a portion of their body that is difficult to view such as the user's back, bottom of a foot, inner ear, or behind the ear. The modular stand may allow the user to take images or videos without requiring them to hold the camera 330 which makes imaging possible in areas the user may not have been able to view due to limited mobility, flexibility, or dexterity.

Expanding on the capabilities of the diabetic visual assessment system 300, the modular stand may incorporate a motorized rotation and elevation mechanism. This mechanism would allow for precise and smooth adjustments of the camera 330 position and orientation. Controlled through a remote device or an app, users can easily adjust the height and angle of the camera, making it ideal for capturing images of hard-to-reach areas without physical strain. The motorized system could be especially beneficial for individuals with limited mobility, offering them greater independence in monitoring their health.

In addition to the telescopic legs 312 and support shaft 316, the tripod stand 310 may include a built-in leveling indicator, such as a bubble level or digital level. This feature ensures that the stand is perfectly balanced, which is crucial for capturing clear and consistent images, especially when documenting the progression of a condition over time. The leveling mechanism can be designed for easy visibility and accessibility, allowing users to quickly adjust the stand to the correct orientation.

Furthermore, the camera mount 318 on the tripod stand 310 could be equipped with an auto-align feature. This feature would automatically orient the camera 330 towards a predefined target area, such as a specific part of the body. Utilizing sensors and pre-set coordinates, the camera mount can adjust the camera's position to ensure that the target area is always in focus and properly framed, simplifying the process for users.

The modular stand may also feature integrated lighting elements. These lighting elements, such as LED rings or adjustable spotlights, can be crucial for creating the optimal lighting conditions necessary for detailed visual assessments, especially in low-light environments. The intensity and color temperature of these lights could be adjustable, either manually or through an app, allowing users to tailor the lighting to their specific needs and improve the quality of captured images or videos.

Additionally, the diabetic visual assessment system 300 might include a wireless charging pad integrated into the base of the modular stand. This feature would allow for convenient charging of the camera 330 and any other compatible devices, such as smartphones or tablets, used in conjunction with the system. The charging pad could be designed to provide fast charging capabilities, reducing downtime and ensuring that the system is always ready for use.

Lastly, considering the user's convenience and ease of use, the modular stand could have foldable or detachable components, making it highly portable and easy to store. This design would be particularly beneficial for users who need to move the system between different locations or have limited storage space. The stand could also include a carrying case with compartments for the stand, camera, and accessories, further enhancing its portability and convenience.

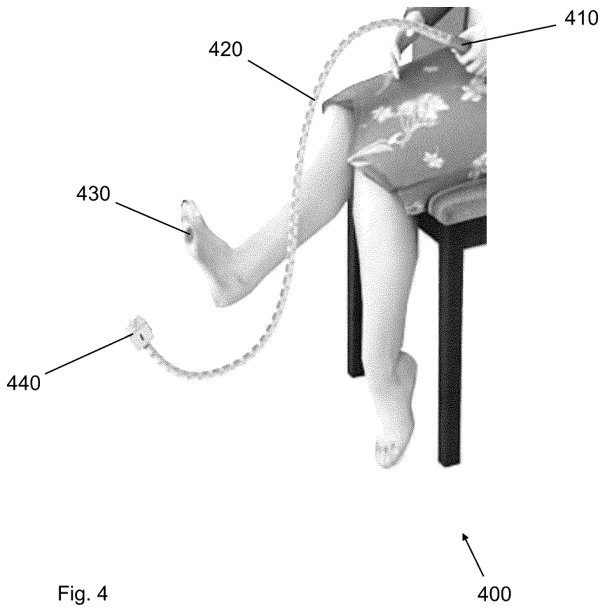

As shown in FIG. 4, a perspective view of using a diabetic visual assessment system 400 is shown. The diabetic visual assessment system 400 may comprise a camera 440, an elongate reconfigurable neck 420 and a coupling handle 410. When used, a user may take images or video of a diabetic wound 430 that may otherwise be out of view of the user.

The diabetic visual assessment system 400 may allow the user to remain in a position that the user is able to achieve and is comfortable such as a seated position or a standing position. The user may position the elongate reconfigurable neck 420 by repositioning the gooseneck segments as shown in FIG. 2. This may allow the user to capture an image or video of their back, bottom of the foot, inner ear, behind the ear or other difficult to image body location using the camera 440.

This diabetic visual assessment system 400 allows a user with limited mobility, such as an elderly user or a person with other physical limitations such as limited dexterity, to capture images or video that would otherwise not be possible. Capturing these images or video allows the user to regularly check the condition of diabetic wounds 430 without the need to first visit a doctor or medical professional and seek treatment when necessary.

Enhancing the capabilities of the diabetic visual assessment system 400, the camera 440 may incorporate advanced imaging features such as macro photography and thermal imaging. Macro photography would allow for close-up, detailed images of diabetic wounds 430, capturing intricacies that are crucial for medical assessment. Thermal imaging could provide insights into the wound's healing process by detecting variations in temperature, indicative of inflammation or infection.

In addition to manual control, the diabetic visual assessment system 400 may include voice-activated controls, enabling hands-free operation. This feature would be particularly beneficial for users with limited dexterity or those who need to maintain a stable position while capturing images. The user could command the system to take a photo, start or stop video recording, or adjust the camera settings using voice commands.

The system could also be equipped with an integrated application compatible with smartphones or tablets. This app could facilitate remote viewing of the camera's feed, allowing users to see the camera's perspective in real-time on their device's screen. This feature would enable users to ensure proper framing and focus before capturing an image or video, especially in hard-to-reach areas.

Furthermore, the diabetic visual assessment system 400 may feature automatic image analysis software. This software could analyze the captured images of diabetic wounds 430 for signs of healing or deterioration. Using AI algorithms, it could highlight areas of concern, such as increased redness or swelling, and suggest if a medical consultation is advisable. This proactive approach to wound monitoring could significantly aid in early detection and treatment of complications.

The elongate reconfigurable neck 420 may also include embedded LEDs or a ring light around the camera lens. This lighting solution would provide consistent, shadow-free illumination, essential for capturing clear and accurate images of the wound. The intensity and color of the light could be adjustable, ensuring optimal lighting conditions for different skin tones and wound types.

Additionally, the diabetic visual assessment system 400 could include data logging capabilities. Each time an image or video is captured, the system could record the date, time, and specific camera settings used. This data, along with the images, could be automatically organized into a digital log or diary. This feature would be valuable for tracking the progression of diabetic wounds 430 over time, providing a comprehensive visual history for both the user and healthcare providers.

Lastly, considering ergonomic design, the coupling handle 410 might be tailored for ease of grip and maneuverability. It could feature a contoured design with a soft, non-slip surface to ensure a secure and comfortable grip, even during extended use. This ergonomic design would minimize strain on the hands and wrists, making the system more accessible and user-friendly, especially for individuals with arthritis or similar conditions.

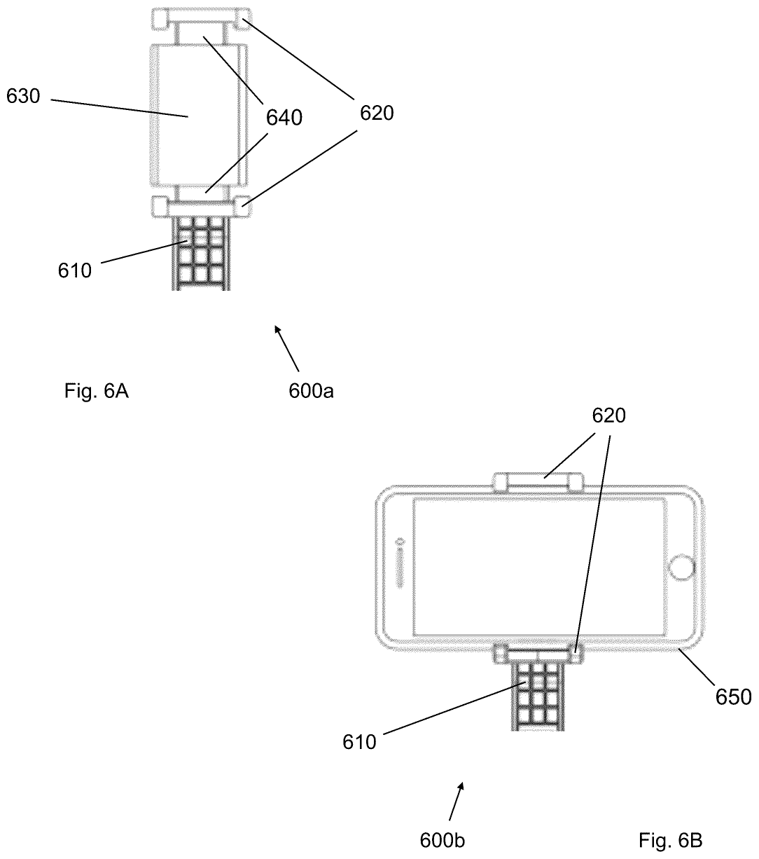

As shown in FIG. 5, a cross-sectional view of a camera coupling system 500 is shown. The camera coupling system 500 may include a camera having a camera body 540, a low-friction bearing sheath 530, a camera coupling bearing 520, and a gooseneck segment 510 as part of an elongate reconfigurable neck. The camera body 540 in FIG. 5 may alternatively be replaced by a camera coupling element as illustrated and described with respect to FIGS. 6A-6B which itself may then couple to the camera body 540. The gooseneck segment 510 may comprise an opening 512 at its terminal end which may be shaped to accept a first shaft portion 522a of the camera coupling bearing 520 therein.

The first shaft portion 522a may terminate at its distal end into a second shaft portion 522b terminating into third shaft portion 522c terminating into a fourth shaft portion 522d terminating into a fifth shaft portion 522e terminating into a terminal ball bearing 524. The outer surfaces of the first and fifth shaft portions 522a, 522e may be disposed parallel relative one another and with at least substantially equal diameters. The outer surface of the third shaft portion 522c may be disposed parallel relative the first and fifth shaft portions 522a, 522e but with a larger diameter. The outer surfaces of the second and fourth shaft portions 522b, 522d may not be disposed in parallel with the first, third and fifth shaft portions 522a, 522c, 522e as illustrated in FIG. 5. Similarly, the first shaft portion 522a may have a non-tapered width or diameter dimension, the second shaft portion 522b may have an outwardly-tapering width or diameter dimension, the third shaft portion 522c may have a non-tapered width or diameter dimension, the fourth shaft portion 522d may have an inwardly-tapered width or diameter dimension, and the firth shaft portion 522e may have a non-taped width or diameter dimension.

The camera body 540 may comprise a cavity with a low-friction bearing sheath 530 contained therein. The low-friction bearing sheath 530 may comprise a plurality of planar edge portions 532 which are engaged and secured within the camera body 540. The low-friction bearing sheath 530 is configured to be held securely within the cavity of the camera body 540. The low-friction bearing sheath 530 may be shaped to receive the camera coupling bearing 520 via a sheath opening 534 disposed between the plurality of planar edge portions 532.

For the optimal fabrication of the low-friction bearing sheath 530 in the camera coupling configuration 500, advanced material choices are paramount. One suitable material for the low-friction bearing sheath 530 is polytetrafluoroethylene (PTFE), commonly known as Teflon. PTFE is renowned for its extremely low coefficient of friction, high heat resistance, and excellent chemical stability. These properties make it an ideal choice for ensuring smooth rotation and durability, even under varying environmental conditions and repetitive use. The material's low friction facilitates the easy insertion and rotation of the camera coupling bearing 520, while its resistance to wear and deformation ensures long-term reliability of the coupling mechanism.

Another advantageous material for constructing the low-friction bearing sheath 530 is Ultra-High Molecular Weight Polyethylene (UHMWPE). UHMWPE is characterized by its exceptional strength-to-weight ratio, high abrasion resistance, and low friction surface. Its self-lubricating properties would contribute to the smooth operation of the camera coupling configuration, reducing the need for maintenance and enhancing the longevity of the system. Additionally, UHMWPE's impact resistance would provide an added layer of protection for the internal components of the camera coupling system, safeguarding it against shocks and vibrations that may occur during use.

In certain applications, a composite material integrating carbon fiber with a polymer matrix, such as epoxy, could be used for the low-friction bearing sheath 530. This composite material would combine the low-friction characteristics of the polymer with the high stiffness and strength of carbon fiber, resulting in a sheath that is both lightweight and robust. This would be particularly beneficial in scenarios where the camera needs to be positioned at various angles and orientations, as the composite material would withstand the mechanical stresses without adding significant weight to the system.

Additionally, the selection of these materials for the low-friction bearing sheath 530 can be further tailored based on specific application requirements, such as temperature range, exposure to chemicals or moisture, and mechanical loading conditions. The flexibility in material choice allows the camera coupling configuration 500 to be adapted for a wide range of environments and usage scenarios, enhancing its applicability and user experience.

The fabrication of the camera coupling bearing 520 and its constituent shaft portions 522a-522e in the camera coupling configuration 500 demands materials that ensure robustness, durability, and smooth interaction with the low-friction bearing sheath 530. A prime candidate for these components is stainless steel, particularly in grades known for their corrosion resistance and strength. Stainless steel offers the requisite hardness to withstand the mechanical stresses involved in the coupling and decoupling actions. Its inherent resistance to corrosion and oxidation ensures longevity and reliable performance, especially in environments with varying humidity and temperature conditions. The smooth surface finish achievable with stainless steel also promotes a seamless interaction with the low-friction bearing sheath 530, facilitating ease of movement and rotation.

In applications where weight reduction is crucial without compromising strength, an aluminum alloy could be employed for the camera coupling bearing 520 and shaft portions 522a-522e. Aluminum alloys are significantly lighter than stainless steel, yet offer commendable strength and durability. Their natural resistance to corrosion and the ability to receive various types of finishes, including anodization, make them well-suited for this application. Anodizing the aluminum can further enhance its surface hardness and wear resistance, making it more durable for repeated use in the camera coupling mechanism.

Another material option for these components is titanium or its alloys. Titanium stands out for its exceptional strength-to-weight ratio, corrosion resistance, and biocompatibility. These characteristics make it an ideal material for camera coupling bearings, particularly in scenarios where lightweight and hypoallergenic properties are priorities. Titanium's natural oxide layer protects it from environmental elements, ensuring the longevity of the camera coupling bearing 520 and shaft portions 522a-522e. Its compatibility with precision machining processes also allows for the creation of intricate and exact geometries required for the smooth and accurate functioning of the camera coupling system.

Additionally, for the camera coupling bearing 520 and shaft portions 522a-522e, composite materials incorporating fiberglass or carbon fiber with a polymer matrix could be considered. These composites offer a balance between strength, weight, and wear resistance, making them suitable for applications where these properties are crucial. The integration of fibers enhances the mechanical strength and stiffness of the polymer matrix, resulting in components that are lightweight yet robust enough to endure the mechanical demands of the camera coupling system.

When attachment to the neck is desired, the partially spherical camera coupling bearing 520 may be inserted into the low-friction bearing sheath 530 by applying a pressure to the camera coupling bearing 520 in the direction of the low-friction bearing sheath 530 when placed at the opening of the cavity of the camera body 540. With sufficient pressure, the camera coupling bearing 520 will be inserted into the cavity and surrounded by the low-friction bearing sheath 530.

Upon insertion into the cavity, the low-friction bearing sheath 530 provides a containment pressure on the camera coupling bearing 520. This allows the camera coupling bearing 520 to be retained in the cavity and held at a fixed position. Additional rotation pressure may be applied to the camera body 540 or the camera coupling bearing 520 to rotate with six degrees of freedom which allows the camera to be positioned at any angle desired. Separation of the camera coupling bearing 520 from the low-friction bearing sheath 530 is achieved by applying an outward force on the camera coupling bearing 520 in the direction away from the low-friction bearing sheath 530 and outward from the cavity.

Enhancing the functionality of the camera coupling configuration 500, the camera body 540 may be equipped with an automatic alignment system. This system would utilize magnetic elements or mechanical guides within the cavity to facilitate easy and precise alignment of the camera coupling bearing 520 with the low-friction bearing sheath 530. The automatic alignment system would simplify the attachment process, particularly beneficial for users with limited dexterity or in situations where precise alignment is challenging.

Additionally, the low-friction bearing sheath 530 could incorporate a locking mechanism. This mechanism would engage once the camera coupling bearing 520 is fully inserted, providing a secure attachment that prevents accidental dislodgment of the camera from the elongate reconfigurable neck. The locking mechanism could be designed to be easily engaged and disengaged, possibly through a simple push-button or twist-lock action, ensuring that the camera can be quickly and safely detached when necessary.

To further enhance the durability and performance of the camera coupling configuration 500, the materials used for the low-friction bearing sheath 530 and camera coupling bearing 520 may be selected for their wear resistance and strength. For instance, the low-friction bearing sheath 530 could be made from high-grade polymers or composites known for their low wear characteristics, ensuring longevity and consistent performance even with frequent use.

The camera coupling configuration 500 might also include a dampening system within the cavity of the camera body 540. This system could consist of shock-absorbing materials or structures designed to minimize the impact of shocks or vibrations on the camera. Such a feature would be particularly useful in scenarios where the camera is used in mobile or unstable environments, helping to maintain image stability and protect the internal components of the camera.

Moreover, the camera body 540 could feature a quick-release mechanism integrated with the low-friction bearing sheath 530. This mechanism would allow for rapid detachment of the camera from the elongate reconfigurable neck, facilitating a swift transition between mounted and handheld usage. The quick-release could be designed to be operable with one hand, adding convenience and speed to the process.

Lastly, considering user safety and equipment protection, the interface between the camera coupling bearing 520 and the low-friction bearing sheath 530 may include a safety catch or fail-safe feature. This feature would prevent complete separation of the camera from the neck unless a specific release action is performed. This safety catch would guard against accidental drops or detachment, ensuring the camera remains securely attached during use, especially in challenging or dynamic shooting conditions.

As shown in FIG. 6A, a perspective view of a camera coupling element 600a is provided. The camera coupling element 600a may comprise a camera retention cavity 630 and a plurality of retention elements 620. The camera retention cavity 630 may have a planar backing to provide aligning support to a display device. Additionally, the camera retention cavity 630 may be sized to hold a display device such as a smartphone or tablet. The planar backing of the camera retention cavity 630 may be coupled to the plurality of retention elements 620 via one or more vertical elongate coupling structures 640.

Retention elements 620 may be positioned on opposing ends of the camera retention cavity 630 and configured to grasp the display device. The retention elements 620 may include protruding portions on each of the outer ends of the retention elements 620. The protruding portions may be sized and shaped to fit around the edge of the display device, including, but not limited to, smartphones, tablets and the like. The protruding portions may be sized to accept a large number of display device models, having various form factors which accounts for the potential use of protective cases as is common with many smartphones and tablets.

The display device may be retained by the retention elements 620 with a force directed inward from each retention element 620. The force may be provided by a spring element, elastic element, screw element, friction element, or the like. Additionally, the camera coupling element 600a may include a coupling mechanism to attach a gooseneck segment 610 as part of an elongate reconfigurable neck with a coupling handle, as described in FIG. 2.

Building upon the design of the camera coupling element 600a, the retention elements 620 may be enhanced with adjustable tension control. This control allows the user to modify the clamping force exerted by the retention elements 620, ensuring a secure yet gentle grip on various display devices. This feature is especially beneficial when accommodating devices of different thicknesses, including those with heavy-duty protective cases. The tension control could be implemented through a dial, a slider, or a screw mechanism, offering a user-friendly way to adjust the grip.

Furthermore, the camera coupling element 600a may feature an integrated charging system for the display device. This system could include wireless charging capabilities or a built-in charging port compatible with common smartphone and tablet models. When a display device is placed within the camera retention cavity 630, it could be charged simultaneously, ensuring that the device remains powered during prolonged use. This feature adds convenience and functionality, making the system more practical for extended sessions or when away from power sources.

The camera coupling element 600a could also incorporate an anti-vibration padding within the camera retention cavity 630. This padding would provide additional protection for the display device against shocks and vibrations during use, especially important in mobile or outdoor environments. The padding material could be a soft, durable rubber or foam, offering both cushioning and grip.

Additionally, the camera coupling element 600a may include a secondary locking mechanism for extra security. This mechanism would ensure that the display device remains firmly in place even under vigorous movements or in situations where the device is oriented in various angles. This could be particularly important for applications in dynamic environments or where accidental dislodging of the device could lead to damage or disruption.

Considering user convenience, the camera coupling element 600a could feature quick-release buttons or levers on the retention elements 620. These quick-release mechanisms would allow for easy and fast insertion and removal of the display device, enhancing the overall user experience and reducing setup time. The design of these mechanisms would be intuitive and accessible, allowing for operation even by users with limited manual dexterity.

As shown in FIG. 6B, a perspective view of a camera coupling element 600b coupled to a display device is provided. The camera coupling element 600b may configured with the same features as referenced by FIG. 6A including a camera retention cavity 630, a plurality of retention elements 620, protruding portions on each of the outer ends of the retention elements 620, and gooseneck segments 610.

Also depicted in FIG. 6B is a display device 650 shown as a smartphone. The display device is placed in the camera retention cavity 630 and held securely by the protruding portions of the retention elements 620. The retention force may be generated by a mechanism which may include, but is not limited to, a spring element, an elastic element, a screw element, a high-friction element and the like or any combination thereof.

The digital display may include a smartphone, tablet, or any other suitable display device. The digital display may be connected to the elongate reconfigurable neck through gooseneck segments 610 at the opposite end from the camera. Utilizing this system allows the user to capture images with the camera, and view the images in real time on the display device.

Upon capturing an image or video, the image or video may be delivered to the display device. The delivery of the image or video may be performed through a wired connection from the camera to the display device or it may be performed through a wireless connection. The camera and display device may cooperatively connect and deliver data through a wireless connection via means including, but not limited to, Bluetooth, NFC, WiFi, infrared and the like, or any other suitable wireless connection means.

The camera may deliver a live feed video stream to the display device. The user may then align the camera with the location of interest on the user's body and capture an image or series of images, or capture a video. The display device may include features to control the function of the camera including capturing images or video, adjusting the image, adjusting the focus, and turning power to the camera on or off. Additionally, the user may use the display device to enlarge images taken with the camera. The images may be sent to medical professionals to determine if a treatment action needs to be performed.

Alternatively, the display device may be connected to the camera with the capability to read image or video data stored on the camera. The user may then select and view stored images or video. Various operations can be performed on the images such as enlarging or editing. Selected images or video may be saved to the display device or sent to a medical professional for assessment.

Alternatively, the display device may be used in place of the camera. Many available display devices including, but not limited to, smartphones, tablets and the like, include a camera capable of capturing images or video. The camera may be a front facing camera or a rear facing camera. Using the display device in place of the camera may be beneficial to a user as there may be lower costs involved to use the diabetes visual assessment system. The functionality of the external camera may be provided to the display device through use of an application executed on the display device for interaction by the user.

With reference to FIGS. 1-6B, a diabetic visual assessment system is provided which operates primarily with the use of a camera. The camera may be a multipurpose camera capable of capturing images or video. The diabetic visual assessment system assists users with limited mobility. Elderly users or those users with limited dexterity may benefit from the additional features provided by the diabetic visual assessment system of the instant application.

In certain embodiments, the system features a camera mountable at the distal end of an elongate reconfigurable neck. This neck is a flexible, adjustable extension designed to enhance the user's reach, enabling precise camera placement in otherwise inaccessible locations. Constructed from a series of gooseneck segments interconnected by inflection joints, the neck provides multi-directional articulation. Each inflection joint is engineered to exert adequate frictional force, ensuring that the gooseneck segments maintain their adjusted configuration under static conditions. This arrangement allows the elongate reconfigurable neck to retain its form until an external force is deliberately applied for repositioning.

Positioned at the proximal end of the elongate reconfigurable neck is a coupling handle, which may be integrally affixed to the terminal gooseneck segment. This handle serves as a manual interface for the user, facilitating ergonomic manipulation of the system. In addition, the handle is equipped with an interface mechanism compatible with a modular stand.

The modular stand, adaptable for attachment to the coupling handle, encompasses various configurations including, but not limited to, tripod, flexible wrap, and fixed stands. Specifically, the tripod stand variant integrates a coupling mechanism compatible with the coupling handle, akin to conventional camera tripod systems. This stand configuration permits hands-free operation of the diabetes visual assessment system, enabling users to position the camera in specific orientations for imaging target body areas such as the back, foot sole, inner ear, or behind the ear. The tripod stand is particularly advantageous for users with limitations in manual steadiness, strength, or dexterity.

Utilizing the diabetic visual assessment system, the user can capture images or videos and subsequently review them on a digital display. This display may include devices such as smartphones, tablets, among others. The system facilitates image enlargement for detailed examination of potential diabetic skin complications. Additionally, the assessment system is compatible with desktop or laptop computers, offering capabilities for image storage, later review, or data documentation. Furthermore, the system supports digital transmission of images or videos to healthcare professionals for advanced evaluation and determination of the necessity for medical intervention.

In some embodiments of FIGS. 1-6B, a diabetic visual assessment system is provided comprising: an elongate reconfigurable neck having a proximal terminal end and a distal terminal end and comprising a gooseneck segment, wherein: the gooseneck segment comprises a plurality of gooseneck sections, each gooseneck section is separated by an articulation joint, and the gooseneck segment comprises a first inflection joint of a plurality of inflection joints disposed between the proximal terminal end and the distal terminal end; and a camera coupling system comprising a cylindrical shaft disposed within a proximal region thereof, wherein: the camera coupling system is disposed at the distal terminal end of the elongate reconfigurable neck, and the cylindrical shaft is coupled to the distal terminal end of the elongate reconfigurable neck.

In some embodiments of FIGS. 1-6B, the elongate reconfigurable neck comprises a plurality of gooseneck segments and each gooseneck segment is separated by one of the plurality of inflection joints, the elongate reconfigurable neck comprises a coupling handle disposed at the proximal terminal end of the elongate reconfigurable neck, the camera coupling system comprises a terminal ball bearing disposed within a distal region thereof, each of the plurality of inflection joints comprise an inflection point in the curvature of the elongate reconfigurable neck, each of the plurality of gooseneck segments comprise a soft metallic core surrounded by a hard metallic coiled spring, the terminal ball bearing is coupled to the cylindrical shaft of the camera coupling system, the soft metallic core and the hard metallic coiled spring comprise a flexible polymer protective layer disposed therearound, and the terminal ball bearing is disposed within a low-friction bearing sheath.

In some embodiments of FIGS. 1-6B, the cylindrical shaft comprises a first shaft portion having a first non-tapered width or diameter dimension, the cylindrical shaft comprises a second shaft portion having an outwardly-tapering width or diameter dimension, the cylindrical shaft comprises a third shaft portion having a second non-tapered width or diameter dimension, the cylindrical shaft comprises a fourth shaft portion having an inwardly-tapering width or diameter dimension, the cylindrical shaft comprises a fifth shaft portion having a third non-tapered width or diameter dimension, the fifth shaft portion is coupled to a terminal ball bearing, the terminal ball bearing is disposed within a low-friction bearing sheath, the low-friction bearing sheath comprises a sheath opening disposed adjacent the fifth shaft portion, and the camera coupling system is removably coupled within a camera or around the camera.

In some embodiments of FIGS. 1-6B, a diabetic visual assessment system is provided comprising: an elongate reconfigurable neck having a proximal terminal end and a distal terminal end and comprising a gooseneck segment, wherein: the gooseneck segment comprises a plurality of gooseneck sections, each gooseneck section is separated by an articulation joint, and the gooseneck segment comprises an inflection joint disposed between the proximal terminal end and the distal terminal end; and a camera coupling system comprising a cylindrical proximal shaft, wherein: the camera coupling system is disposed at the distal terminal end of the elongate reconfigurable neck, the camera coupling system is coupled to a camera or a camera coupling element via a bearing, the bearing is disposed within a low-friction bearing sheath allowing for relative rotation between the bearing and the camera or the camera coupling element, and the cylindrical proximal shaft is coupled to the distal terminal end of the elongate reconfigurable neck.

In some embodiments of FIGS. 1-6B, a diabetic visual assessment system is provided comprising: an elongate reconfigurable neck having a proximal terminal end and a distal terminal end and comprising a gooseneck segment, wherein: the gooseneck segment comprises a plurality of gooseneck sections, each gooseneck section is separated by an articulation joint, and the gooseneck segment comprises an inflection joint disposed between the proximal terminal end and the distal terminal end; and a camera coupling system comprising a cylindrical proximal shaft, wherein: the camera coupling system is disposed at the distal terminal end of the elongate reconfigurable neck, the camera coupling system further comprises a camera coupling element which comprises a plurality of retention elements, one or more vertical coupling structures, and a camera retention cavity, a bearing is disposed within one of the plurality of retention elements, the bearing rotates relative the plurality of retention elements via a low-friction bearing sheath, and the cylindrical proximal shaft is coupled to the distal terminal end of the elongate reconfigurable neck.

The specification and drawings are to be regarded in an illustrative rather than a restrictive sense. However, it will be evident that various modifications and changes may be made thereunto without departing from the broader spirit and scope of the invention as set forth in the claims. Other variations are within the spirit of the present disclosure. Thus, while the disclosed techniques are susceptible to various modifications and alternative constructions, certain illustrated embodiments thereof are shown in the drawings and have been described above in detail. It should be understood, however, that there is no intention to limit the invention to the specific form or forms disclosed, but on the contrary, the intention is to cover all modifications, alternative constructions, and equivalents falling within the spirit and scope of the invention, as defined in the appended claims.

All features disclosed in the specification, claims, abstract, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent, or similar purpose, unless expressly stated otherwise.

Throughout this disclosure, the phrase ‘modularly coupled’ and similar terms and phrases are intended to convey that any element of a given class of elements may be coupled to another given element and vice versa with equal effect. For example, any extension cord of a plurality of extension cords may be modularly coupled to another extension cord and vice versa with equal effect. Further, throughout this disclosure, the phrase ‘removably coupled’ and similar terms and phrases are intended to convey that a given element may be iteratively coupled to and removed from another given element as desired. For example, a male plug of a first extension cord may be removably coupled to a female plug of a second extension cord as desired.

The use of the terms “a,” “an,” “the,” and similar referents in the context of describing the disclosed embodiments (especially in the context of the following claims) are to be construed to cover both the singular and the plural, unless otherwise indicated or clearly contradicted by context. The terms “comprising,” “having,” “including,” and “containing” are to be construed as open-ended terms (i.e., meaning “including, but not limited to,”) unless otherwise noted. The term “coupled” or “connected,” where unmodified and referring to physical connections, is to be construed as partly or wholly contained within, attached to, or joined together, even if there is something intervening. Recitation of ranges of values are merely intended to serve as a shorthand method of referring individually to each separate value falling within the range, unless otherwise indicated and each separate value is incorporated into the specification as if it were individually recited. The use of the term “set” (e.g., “a set of items”) or “subset” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but the subset and the corresponding set may be equal.

Conjunctive language, such as phrases of the form “at least one of A, B, and C,” or “at least one of A, B and C,” is understood with the context as used in general to present that an item, term, etc., may be either A or B or C, or any nonempty subset of the set of A and B and C, unless specifically stated otherwise or otherwise clearly contradicted by context. For instance, in the illustrative example of a set having three members, the conjunctive phrases “at least one of A, B, and C” and “at least one of A, B and C” refer to any of the following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, the term “plurality” indicates a state of being plural (e.g., “a plurality of items” indicates multiple items). The number of items in a plurality is at least two, but can be more when so indicated either explicitly or by context.

The use of any examples, or exemplary language (e.g., “such as”) provided, is intended merely to better illuminate embodiments of the invention and does not pose a limitation on the scope of the invention unless otherwise claimed. No language in the specification should be construed as indicating any non-claimed element as essential to the practice of the invention.

Embodiments of this disclosure are described, including the best mode known to the inventors for carrying out the invention. Variations of those embodiments may become apparent to those of ordinary skill in the art upon reading the foregoing description. The inventors expect skilled artisans to employ such variations as appropriate and the inventors intend for embodiments of the present disclosure to be practiced otherwise than as specifically described. Accordingly, the scope of the present disclosure includes all modifications and equivalents of the subject matter recited in the claims appended hereto as permitted by applicable law. Moreover, although above-described elements may be described in the context of certain embodiments of the specification, unless stated otherwise or otherwise clear from context, these elements are not mutually exclusive to only those embodiments in which they are described; any combination of the above-described elements in all possible variations thereof is encompassed by the scope of the present disclosure unless otherwise indicated or otherwise clearly contradicted by context.

All references, including publications, patent applications, and patents, cited are hereby incorporated by reference to the same extent as if each reference were individually and specifically indicated to be incorporated by reference and were set forth in its entirety.

1. A diabetic visual assessment system, comprising:
an elongate reconfigurable neck having a proximal terminal end and a distal terminal end and comprising a gooseneck segment, wherein:
the gooseneck segment comprises a plurality of gooseneck sections, each gooseneck section is separated by an articulation joint, and
the gooseneck segment comprises a first inflection joint of a plurality of inflection joints disposed between the proximal terminal end and the distal terminal end; and
a camera coupling system comprising a cylindrical shaft disposed within a proximal region thereof, wherein:
the camera coupling system is disposed at the distal terminal end of the elongate reconfigurable neck, and
the cylindrical shaft is coupled to the distal terminal end of the elongate reconfigurable neck.

2. The diabetic visual assessment system of claim 1, wherein the elongate reconfigurable neck comprises a plurality of gooseneck segments and each gooseneck segment is separated by one of the plurality of inflection joints.

3. The diabetic visual assessment system of claim 2, wherein the elongate reconfigurable neck comprises a coupling handle disposed at the proximal terminal end of the elongate reconfigurable neck.

4. The diabetic visual assessment system of claim 3, wherein the camera coupling system comprises a terminal ball bearing disposed within a distal region thereof.

5. The diabetic visual assessment system of claim 4, wherein each of the plurality of inflection joints comprise an inflection point in the curvature of the elongate reconfigurable neck.

6. The diabetic visual assessment system of claim 5, wherein each of the plurality of gooseneck segments comprise a soft metallic core surrounded by a hard metallic coiled spring.

7. The diabetic visual assessment system of claim 6, wherein the terminal ball bearing is coupled to the cylindrical shaft of the camera coupling system.

8. The diabetic visual assessment system of claim 7, wherein the soft metallic core and the hard metallic coiled spring comprise a flexible polymer protective layer disposed therearound.

9. The diabetic visual assessment system of claim 8, wherein the terminal ball bearing is disposed within a low-friction bearing sheath.

10. The diabetic visual assessment system of claim 1, wherein the cylindrical shaft comprises a first shaft portion having a first non-tapered width or diameter dimension.

11. The diabetic visual assessment system of claim 10, wherein the cylindrical shaft comprises a second shaft portion having an outwardly-tapering width or diameter dimension.

12. The diabetic visual assessment system of claim 11, wherein the cylindrical shaft comprises a third shaft portion having a second non-tapered width or diameter dimension.

13. The diabetic visual assessment system of claim 12, wherein the cylindrical shaft comprises a fourth shaft portion having an inwardly-tapering width or diameter dimension.

14. The diabetic visual assessment system of claim 13, wherein the cylindrical shaft comprises a fifth shaft portion having a third non-tapered width or diameter dimension.

15. The diabetic visual assessment system of claim 14, wherein the fifth shaft portion is coupled to a terminal ball bearing.

16. The diabetic visual assessment system of claim 15, wherein the terminal ball bearing is disposed within a low-friction bearing sheath.

17. The diabetic visual assessment system of claim 16, wherein the low-friction bearing sheath comprises a sheath opening disposed adjacent the fifth shaft portion.

18. The diabetic visual assessment system of claim 17, wherein the camera coupling system is removably coupled within a camera or around the camera.

19. A diabetic visual assessment system, comprising:
an elongate reconfigurable neck having a proximal terminal end and a distal terminal end and comprising a gooseneck segment, wherein:
the gooseneck segment comprises a plurality of gooseneck sections, each gooseneck section is separated by an articulation joint, and
the gooseneck segment comprises an inflection joint disposed between the proximal terminal end and the distal terminal end; and
a camera coupling system comprising a cylindrical proximal shaft, wherein:
the camera coupling system is disposed at the distal terminal end of the elongate reconfigurable neck,
the camera coupling system is coupled to a camera or a camera coupling element via a bearing,
the bearing is disposed within a low-friction bearing sheath allowing for relative rotation between the bearing and the camera or the camera coupling element, and
the cylindrical proximal shaft is coupled to the distal terminal end of the elongate reconfigurable neck.

20. A diabetic visual assessment system, comprising:
an elongate reconfigurable neck having a proximal terminal end and a distal terminal end and comprising a gooseneck segment, wherein:
the gooseneck segment comprises a plurality of gooseneck sections, each gooseneck section is separated by an articulation joint, and
the gooseneck segment comprises an inflection joint disposed between the proximal terminal end and the distal terminal end; and
a camera coupling system comprising a cylindrical proximal shaft, wherein:
the camera coupling system is disposed at the distal terminal end of the elongate reconfigurable neck,
the camera coupling system further comprises a camera coupling element which comprises a plurality of retention elements, one or more vertical coupling structures, and a camera retention cavity,
a bearing is disposed within one of the plurality of retention elements, the bearing rotates relative the plurality of retention elements via a low-friction bearing sheath, and
the cylindrical proximal shaft is coupled to the distal terminal end of the elongate reconfigurable neck.
